(19) United States
(12) Patent Application Publication
(10) Pub. No.: US 2026/0111653 A1
(43) Pub. Date: Apr. 23, 2026

(54) SYSTEM

(71) Applicant: SOFTBANK GROUP CORP., Tokyo (JP)

(72) Inventor: Naho AKATSU, Tokyo (JP)

(73) Assignee: SOFTBANK GROUP CORP., Tokyo (JP)

(21) Appl. No.: 19/356,461

(22) Filed: Oct. 13, 2025

(30) Foreign Application Priority Data
Oct. 17, 2024 (JP) 2024-181643

(51) Int. Cl. G06F 40/174; G06F 40/30

(52) U.S. Cl. CPC G06F 40/174; G06F 40/30

(57) ABSTRACT

A system includes a processor that is configured to receive information from a user and check the format of the input data, collect information regarding various procedures and update a database, automatically generate a document for application purposes based on the received input data and fill in appropriate fields, provide the generated document and related information to the user, and notify the user of a set deadline and prompt action.

### CROSS-REFERENCE TO RELATED APPLICATION

This application is based on and claims priority under 35 USC 119 from Japanese Patent Application No. 2024-181643 filed on Oct. 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventionally, procedures for municipal applications are complicated and time-consuming due to differences in formats and requirements among municipalities, as well as the need for users to search for accurate information, input data in specific formats, generate documents manually, and remember submission deadlines. Furthermore, users who are not familiar with the procedural language or who have accessibility needs face additional challenges. There is a strong need for a system that can simplify and streamline application procedures, reduce user error, and provide effective support throughout the process.

### SUMMARY

The present invention provides a system comprising a processor configured to receive user information and check the format of input data, collect various procedural information and update a database, automatically generate application documents based on user inputs and fill in appropriate fields, and provide the generated documents and related information to the user. The system further notifies the user of submission deadlines to prompt timely action. In addition, the system may analyze input data using natural language processing technology and provide voice guidance to enhance accessibility and further streamline the application procedure.

“Processor” means a hardware component or circuitry capable of executing instructions and processing data to perform the specified functions of the system.

“Input data” means information provided by the user, including personal details and procedural selections, which is required for generating application documents.

“Format of the input data” means the structure, arrangement, and required data types that the user information must conform to for successful processing.

“Procedures” means various official tasks or applications required by municipalities or administrative bodies, such as change of address, benefits claims, or other formal requests.

“Database” means a structured data storage system used to organize, manage, and update information regarding procedural requirements and formats from different municipalities.

“Automatically generate” means the system creates application documents without manual intervention, using programmed logic and user-provided input.

“Document for application purposes” means an official form or paperwork required to complete a specific municipal application or procedure.

“Fields” means distinct sections or data entry locations in an application document that must be filled in with relevant and accurate information.

“Related information” means supplementary details provided to the user, including required supporting materials or instructions relevant to the application process.

“Deadline” means the predetermined date or time by which the user must complete or submit the required application documents.

“Natural language processing technology” means computational methods and algorithms which enable the system to interpret and analyze user language input in a manner similar to how humans understand language.

“Voice guide” means a feature which provides spoken instructions or feedback to the user to assist in completing the application procedure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

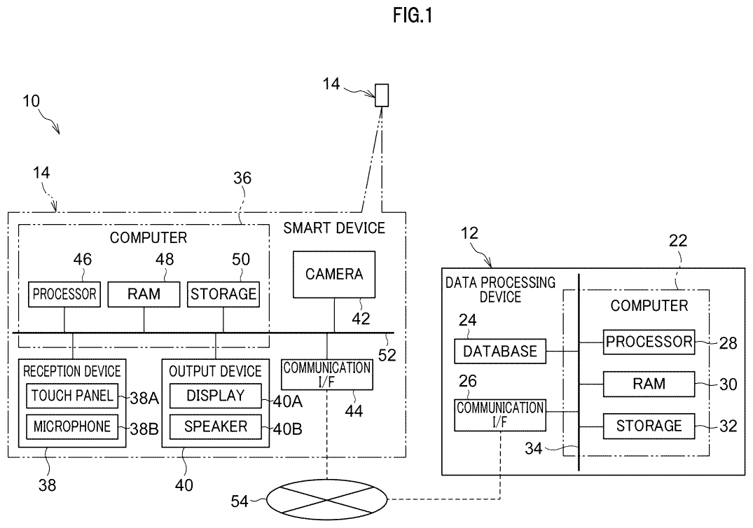

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

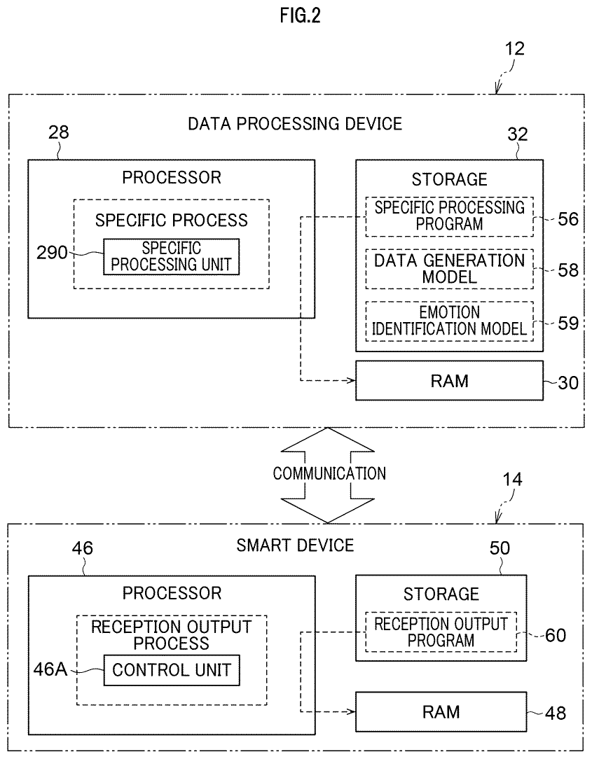

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In modern society, administrative application procedures are often complex and time-consuming due to varying formats, requirements, and deadlines across different governmental institutions. Users are further burdened by the need to understand specific documentation formats, submit accurate data, and manage important deadlines, often in unfamiliar languages or under unfamiliar procedural rules. As a result, there is a need for a system that allows users to efficiently and easily complete administrative application procedures, ensuring accuracy, compliance, and timely submission regardless of institutional differences.

The specific processing by the specific processing unit 290 of the data processing device 12 in Example 1 is realized by the following means.

The present invention provides a server comprising a processor configured to automatically acquire and centrally manage administrative procedure information from multiple public institutions via a communication network, verify and structure user input data, generate prompts for a generative artificial intelligence model to automatically create application documents, output the generated documents and procedural guidance visually or audibly, and automatically notify users of deadlines to prompt timely action. This enables users to efficiently complete complex administrative procedures with minimal effort, ensuring data accuracy, format compliance, and proactive deadline management across diverse governmental operations.

The term “processor” refers to a computing unit or circuitry configured to execute instructions and perform data processing tasks necessary for implementing the system's functions.

The term “user” refers to an individual or organization that interacts with the system to initiate, input information for, or complete administrative procedures.

The term “input data” refers to any information or content provided by the user, including but not limited to personal details, application contents, and documentation required for administrative procedures.

The term “structure and logical consistency” refers to the conformity of input data with prescribed formats and the internal coherence of information required to successfully process an administrative procedure.

The term “administrative procedure information” refers to details, requirements, and rules set by public institutions regarding the process for filing, submitting, or managing official applications.

The term “public institution” refers to a governmental organization or entity responsible for managing administrative procedures and providing official services to the public.

The term “communication network” refers to any wired or wireless medium or infrastructure that enables data transmission between the system and external data sources, including the Internet or private networks.

The term “information acquisition technology” refers to techniques or tools, such as web scraping, APIs, or automated scripts, that automatically obtain and update administrative procedure information from external data sources.

The term “information storage device” refers to physical or virtual hardware or memory used by the system to store, organize, and update administrative procedure information and related user data.

The term “unified record structure” refers to a standardized data schema that organizes diverse administrative procedure information from multiple sources into a consistent and interoperable format.

The term “prompt sentence” refers to a specifically formatted textual input designed to elicit a desired response or document generation from a generative artificial intelligence model.

The term “generative artificial intelligence model” refers to an automated machine learning-based system capable of producing texts or documents in response to input data or prompts.

The term “application document” refers to an official form or record generated by the system, intended for submission to a public institution as part of an administrative procedure.

The term “procedural information” refers to guidance, instructions, or details related to the steps required to complete an administrative process.

The term “display device” refers to any electronic equipment, such as screens or speakers, configured to present visual or audio information to the user.

The term “deadline management information” refers to data or metadata indicating timeframes or due dates relevant to an administrative procedure.

The term “notification information” refers to messages or alerts generated by the system to inform or remind the user regarding deadlines or procedural actions.

The term “terminal” refers to any end-user computing device, such as a smartphone, tablet, or computer, that enables user interaction with the system.

The term “natural language processing technology” refers to computational methods that analyze, interpret, and process human language input in order to facilitate automated data extraction, comprehension, or document generation.

The term “voice input/output technology” refers to systems or components that enable the reception of spoken user input or the generation of audible output, including speech recognition and speech synthesis mechanisms.

One embodiment for implementing the present invention is described below.

The server is implemented using a general-purpose computing device, such as a cloud-based or on-premises computer system equipped with a processor, memory, and storage means. The server operates system software such as a Linux operating system, and is capable of running application logic implemented using programming languages such as Python or JavaScript.

The server hosts software tools for web data acquisition such as web scraping frameworks (for example, Scrapy or Beautiful Soup), manages communication with external public institution databases through API interfaces, and regularly updates administrative procedure information.

The server further manages a database system (for example, PostgreSQL or MySQL) as an information storage device. When information regarding governmental procedure changes or new requirements is obtained, the server processes and saves this information in a unified data structure within the database. The server has modules for monitoring data update schedules, and all data acquisition, transformation, and registration operations are automated through scheduled scripts and logging mechanisms.

The terminal is implemented using an end-user device, such as a smartphone, tablet, or personal computer, operating a dedicated application or web-based client interface. The terminal integrates user interface frameworks (such as React Native or Flutter), supports text and voice data entry using speech-to-text engines (such as Google Speech-to-Text API), and provides output guidance using text display and text-to-speech systems (such as Google Text-to-Speech or equivalent).

The user interacts with the terminal to select an intended administrative procedure, enters necessary information such as name and address by text or voice, and reviews or corrects automatically validated data entries. The terminal performs data validation using locally implemented logic in JavaScript or Python to ensure that all information conforms to expected formats and is logically consistent.

Upon successful validation, the terminal transmits structured user input data to the server for document generation. The server takes the verified user data, generates an appropriate prompt sentence, and sends it to a generative artificial intelligence model (for example, an LLM such as GPT-4 or a similar large language model service running either on a cloud AI platform or an on-premises GPU server). The AI model receives the prompt, analyzes the user-provided information, and automatically generates the textual content of an application document compliant with the procedures and requirements of the relevant public institution.

The server processes the generated document output and formats it to match the official layout of the required application. It then transmits the finalized document back to the terminal. The terminal presents the document on the screen using a PDF viewer or similar plugin, and also guides the user verbally regarding next steps, deadlines, and submission instructions through the text-to-speech function.

The server calculates deadlines based on the procedural information in the database and includes such information in the response to the terminal. The terminal registers deadline and reminder events in the device's calendar, and pushes notifications or sends emails to the user in advance of the deadline. The user can then use the terminal to save, print, or send the completed application document as needed.

For example, when a user wishes to file a resident relocation notification, the user inputs their old and new address by speech. The terminal uses a speech-to-text engine to convert this to written data and verifies proper format. The server utilizes the following prompt sentence when requesting document generation from the generative AI model:
“Generate an official resident relocation form using these data: Name: [applicant name], Old address: [old address], New address: [new address], Move date: [date].”

The generative AI model then returns a completed application form tailored to the requirements of the relevant local authority. The terminal displays the document to the user and issues notifications such as, “Please submit this form to the municipal office before [deadline].”

Through the comprehensive integration of a data-acquisition server, generative AI-powered document creation, multimodal user interfaces, and deadline management modules, the present invention enables any user to prepare, review, and timely submit administrative applications with high efficiency and accuracy, regardless of differences in institutional procedures or individual user constraints.

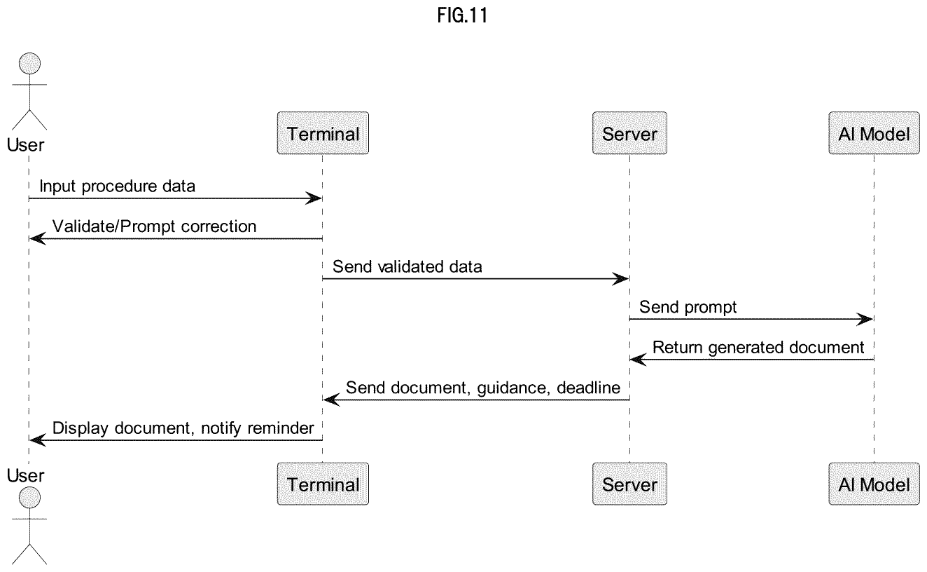

The following describes the processing flow using FIG. 11.

### Step 1:

The server initiates a scheduled data acquisition process using web scraping tools and API requests. The input is a list of URLs and API endpoints provided by multiple public institutions. The server processes these sources to extract administrative procedure information, converts the data into a unified record structure, and updates the information storage device. The output is an updated database containing current administrative procedure data, stored in a standardized format.

### Step 2:

The user operates the terminal to select the desired administrative procedure and provides necessary information through text input, speech input, or selection from on-screen options. The input is raw user data such as name, address, and procedure type. The terminal validates the format and logical consistency of this user input by analyzing the data and applying predetermined rules. The output is validated and structured user input ready for further processing.

### Step 3:

The terminal transmits the validated user input data to the server using a secure communication protocol. The input is the structured and verified application-related data. The server uses this data to generate a prompt sentence, which is then sent to the generative AI model for processing. The server receives the result from the generative AI model, extracts the necessary contents for the application document, and formats it according to the requirements of the relevant public institution. The output is a finalized application document in a predetermined layout and structure.

### Step 4:

The server sends the generated application document and procedural guidance information to the terminal. The input is the completed application document and any supplemental guidance or instruction data. The terminal displays the document using a PDF viewer or native display interface and utilizes text-to-speech functions to provide audible guidance on submission steps and deadlines. The output is the visual and/or audible presentation of the document and instructions to the user.

### Step 5:

The server or terminal calculates the relevant deadline for the user's submission based on the administrative procedure requirements. The input is deadline metadata embedded within the administrative procedure data or generated during the document creation step. The terminal registers deadline and reminder notifications in the device calendar and schedules push notifications or emails to the user. The output is a series of reminders sent to the user's device to prompt timely application submission.

### Step 6:

The user reviews the presented application document and instructions. The input is the displayed document and related procedural guidance. The user decides to save, print, or electronically submit the document as appropriate. The output is the user's completed application, now ready for physical or electronic submission to the designated public institution.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In administrative or business procedures that require application document preparation, users often face complex forms, unclear requirements, and inflexible interfaces, leading to errors, delays, and increased stress. Furthermore, the need to manually reference up-to-date procedural requirements and handle electronic payments separately creates additional burden for users. Conventional systems do not sufficiently automate the aggregation of procedure data, user input analysis, and document generation, nor do they adapt to user emotions or provide personalized reminders, resulting in inefficient and unsatisfactory user experiences.

The specific processing by the specific processing unit 290 of the data processing device 12 in Application Example 1 is realized by the following means.

The present invention provides a server comprising a processor configured to acquire user input, verify information completeness, obtain and update procedure information, construct and transmit prompt sentences to a generative AI model to automatically generate application media, present the generated documents for user confirmation or revision, facilitate electronic payments, manage deadline reminders, and estimate and adapt to user emotion in guidance and notifications. This enables efficient and accurate completion of complex procedural applications, streamlining user interaction, reducing errors and emotional burden, and ensuring timely completion by integrating adaptive guidance and reminder functionalities.

The term “input device” refers to any apparatus or interface configured to receive information from a user, including but not limited to a keyboard, touchscreen, microphone, or other user interaction means.

The term “processor” refers to a hardware processing unit, such as a central processing unit (CPU), microcontroller, or system-on-chip (SoC), configured to execute programmed instructions for data processing and control.

The term “external information source” refers to any system, service, or network resource, including servers, databases, or web APIs, from which procedure-related information can be acquired.

The term “information storage device” refers to a data storage unit or memory, such as a database, hard drive, or non-volatile memory, where procedure information and user data are stored and managed.

The term “natural language generation processing device” refers to a computing resource or cloud-based service implementing a generative artificial intelligence model, that is configured to produce textual documents or responses from structured prompt sentences.

The term “prompt sentence” refers to a structured textual query or instruction generated by the system, used to specify the content to be produced by a natural language generation processing device based on context and user data.

The term “medium” refers to an electronic document, form, or data structure automatically generated for the purpose of completing an application or procedural task.

The term “output device” refers to equipment or interface components, such as a display screen, speaker, or printer, used to present generated media and information to a user.

The term “payment processing device” refers to any software or hardware system capable of processing electronic payments, such as payment gateways, virtual terminals, or integrated circuits for secure transactions.

The term “notification device” refers to any system function or physical component configured to issue alerts or reminders to the user, including but not limited to push notifications and audio signals.

The term “emotion estimation” refers to the process of analyzing user input or voice data to deduce a user's emotional state, such as stress, calmness, or confusion, based on detectable features.

The term “guidance expression” refers to the content and style of instructions or messages presented to the user, which may be dynamically modified according to emotion estimation results and procedural context.

In an embodiment for implementing the invention, the system comprises a server, a terminal, and a user, with the cooperation of various input/output and processing devices as described below.

The server includes a processor, which may be realized by general-purpose computer hardware, such as a central processing unit (CPU), memory, and storage hardware. The server is connected to an information storage device, such as a database system (for example, a relational database like PostgreSQL or a NoSQL database like MongoDB), for storing and updating procedure-related information. The server also has connectivity to external information sources, which may include municipal or organizational databases and official websites accessible via web APIs or web scraping methods.

The terminal is realized by a client-side device used by the user, such as a smartphone, personal computer, or tablet. The terminal is equipped with input devices that may include a touchscreen, keyboard, and microphone, as well as output devices such as a display screen and speaker. The terminal runs software that can accept user input via text or voice, and may use a web browser or a dedicated application.

Upon system startup, the server automatically acquires and updates procedure information from external information sources. Such acquisition may use HTTP-based web APIs or web scraping, and the acquired information is parsed and stored in the information storage device. The user interacts with the terminal to initiate a procedure, such as applying for an official document. The user may enter required information through the touchscreen or by speaking into the microphone. When voice input is provided, the terminal uses voice recognition technology (for example, a cloud-based speech-to-text service) to transcribe the speech to text. For both text and transcribed input, the terminal then invokes a natural language processing module, which may utilize a natural language cloud service or a software library such as a generic natural language API, to analyze the input and extract the user's intent and relevant data fields.

The terminal verifies the format and completeness of the input information according to configuration data received from the server. Upon validation, the terminal transmits the structured user information to the server, using a secure communication channel such as HTTPS.

On the server side, the processor references the procedure requirements stored in the information storage device, and constructs a prompt sentence for a generative AI model. This generative AI model may be realized by a large language model service operating in the cloud and accessible via API. The prompt sentence is created by combining the extracted user data and the necessary requirements for the target procedure.

As an example, if the user wishes to submit a tax payment application, the constructed prompt may be as follows:
“Generate a tax payment application form. The user's name is Yamada Taro, address is 123 Tokyo St, taxpayer number is 123456, deadline is June 20.”

The server sends this prompt to the generative AI model via API, and receives a generated document or data structure representing the application form. The server then optionally analyzes the completeness of the generated document and checks for any missing or ambiguous fields.

If the procedure requires payment, the server communicates with a payment processing device or online payment gateway, such as a generic payment API, to set up the payment information and generates a payment link or code. The server includes this information in the document or as an additional instruction.

The server returns the generated document and associated information to the terminal, which displays it for the user. The terminal may further invoke a guidance module that can issue instructions or guidance via the display and speaker. If the system includes emotion estimation functionality, the terminal or server analyzes user input or voice data to evaluate the user's emotional state, and dynamically adjusts the language or tone of the guidance accordingly.

The terminal also manages deadline information for the procedure by reading metadata from the document and sets local reminders for the user, for example, via push notifications or voice alerts.

The user reviews the displayed document, makes corrections as necessary, and confirms the content. Upon completion and after electronic payment if required, the user receives a confirmation notification from the server via the terminal.

This embodiment enables the integration of procedure information aggregation, user intent extraction using natural language processing, flexible application document generation via generative AI models, adaptive user guidance, electronic payment, and deadline management with reminders, all in a seamless interactive environment suited for end users.

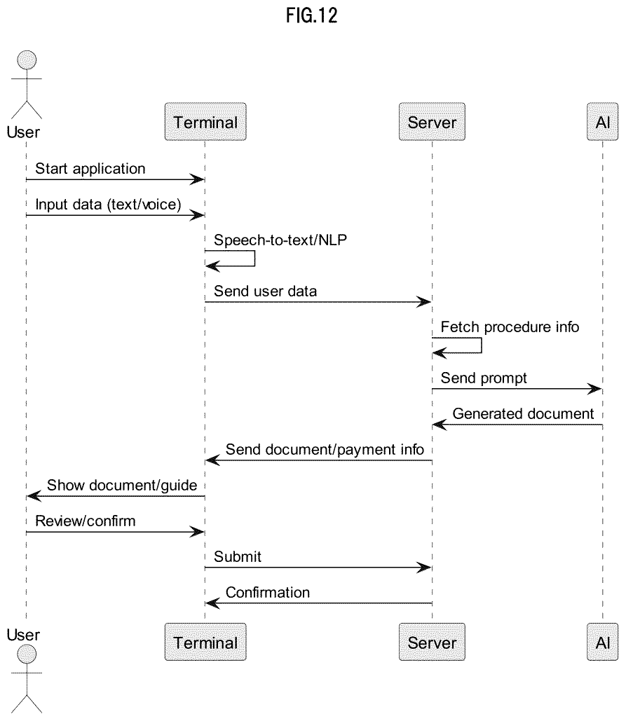

The following describes the processing flow using FIG. 12.

### Step 1:

The server retrieves up-to-date procedural information from external data sources, such as public administration databases or websites, using API calls or web scraping. The input is API endpoint URLs or web page addresses, and the output is structured procedural information (e.g., application requirements, field lists, deadlines). The server parses, validates, and stores this data in a local database for further use.

### Step 2:

The user launches the application on the terminal and chooses or describes the desired procedure by providing text input or speaking into the microphone. The input is a raw text or audio signal, and the output is a user query representing the application intent.

### Step 3:

The terminal converts any voice input into text using speech recognition software and analyzes both text and transcribed input with a natural language processing module to extract user intent and relevant fields, such as name or application type. The input is the user query (text or audio), and the output is structured user information with detected intent and extracted key-value pairs.

### Step 4:

The terminal checks the format and completeness of the extracted user information, referencing requirements it obtained from the server. The input is the structured user information, while the output is either a validation success or a prompt for the user to correct or complete missing/invalid fields. The terminal displays appropriate suggestions or corrections to guide the user.

### Step 5:

The terminal transmits the validated user data to the server over a secure channel (e.g., HTTPS). The input is the validated user information, while the output is the successful receipt and logging of this data on the server.

### Step 6:

The server receives the data and references the corresponding procedural details in the local database. The server creates a prompt sentence tailored for the target generative AI model, combining user-provided information with procedure requirements. The input is structured user information and procedural data, and the output is a prompt sentence (e.g., “Generate a tax payment application form. The user's name is . . . ”).

### Step 7:

The server sends the prompt sentence to the generative AI model using its API and receives a draft application document, such as a completed form or text. The input is the prompt sentence, and the output is the generated application document. The server checks the completeness and accuracy of the generated content before proceeding.

### Step 8:

If payment is required for the procedure, the server interacts with a payment gateway to generate payment information, such as a payment URL or QR code. The input is the procedural requirement for payment and user identification, and the output is electronic payment instructions linked to the application.

### Step 9:

The server returns the generated application document, payment information, and any relevant messages to the terminal. The input is the generated form and payment details, and the output is the data sent to the terminal for user review.

### Step 10:

The terminal displays the application document and associated information to the user, highlighting any incomplete fields or additional actions required. The terminal also uses a speech synthesis module to provide verbal guidance, adapting its language and tone if emotion estimation is enabled. The input is the application document and guidance instructions, and the output is the on-screen display and/or audio guidance.

### Step 11:

The user reviews and optionally edits the application document on the terminal. The input is the displayed document, and the output is the finalized user-approved document, or further edits that are checked by the terminal for validity and completeness.

### Step 12:

The terminal schedules notifications or reminders based on the deadline metadata in the application. The input is deadline-related information extracted from the document, and the output is a scheduled local notification or alert for the user.

### Step 13:

The user confirms and submits the completed application document back to the server via the terminal. The input is the finalized document, and the output is the submission confirmation and request logging on the server.

### Step 14:

The server logs the transaction details and, if payment was completed, issues a final completion and payment confirmation to the terminal. The input is submission and payment data, and the output is the confirmation message to the user and record update in the database.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern society, procedures for submitting applications to public organizations are often complicated and time-consuming. Users frequently face difficulties in collecting all the necessary information, ensuring completeness and correctness of the required data, and generating accurate application documents. Furthermore, existing systems generally do not take into account the emotional state of users, resulting in increased stress or anxiety during the application process. There is a need for a system that can not only streamline and automate these administrative procedures, but also provide emotional support to users, thereby reducing psychological burden and improving the overall user experience.

The specific processing by the specific processing unit 290 of the data processing device 12 in Example 2 is realized by the following means.

The present invention provides a server comprising a processor configured to receive user input information, verify completeness and consistency, collect procedural information resources from external sources, analyze the emotional state of the user, dynamically adjust the user interface according to emotional analysis results, automatically generate application documents using a generative artificial intelligence model, provide the generated documents for user editing and review, and manage and notify users of procedural deadlines. This enables accurate, efficient, and user-friendly automation of administrative applications while reducing user stress and improving user satisfaction through emotional support and intelligent guidance.

The term “input information” refers to data provided by a user for the purpose of completing a procedural application, including but not limited to personal details, addresses, and relevant supporting facts.

The term “completeness and consistency” refers to the state in which all required data fields are appropriately filled and logically coherent in relation to each other for a given procedural task.

The term “procedural information resources” refers to data sets or content related to administrative, governmental, or institutional processes, including instructions, form templates, and procedural requirements collected from external information sources.

The term “information aggregation” refers to a structured storage of procedural information resources, such as databases or data repositories, maintained for up-to-date access and retrieval during application processing.

The term “emotional state” refers to the psychological status of a user inferred from non-verbal and behavioral indicators such as voice tone, speech patterns, or input behavior, including but not limited to stress, anxiety, or calmness.

The term “operation interface” refers to a user-facing display or interaction surface, including graphical user interfaces and audio output guides, through which a user communicates with the system.

The term “presentation content or response expressions” refers to the displayed messages, guidance, prompts, or feedback information on the operation interface, including dynamic adaptations to address the user's emotional state.

The term “generative artificial intelligence model” refers to a computational model trained to produce tailor-made textual or document outputs based on input prompts, including, but not limited to, machine learning-based language processing systems.

The term “instruction sentence” refers to a textual directive constructed for submission to a generative artificial intelligence model, containing user inputs and system guidance to drive automated document generation.

The term “application electronic document” refers to a digital form or record generated for submission to a public organization or authority, constructed based on user input information and procedural requirements.

The term “information processing terminal” refers to an electronic device operated by the user, such as a smartphone, tablet, or computer, that communicates with the server for data exchange and user interface presentation.

The term “procedural deadline information” refers to time-related data stipulating the latest timing for submission, update, or action in connection with the procedural application.

The term “notification” refers to an alert or reminder communicated to a user, via the operation interface or terminal, to encourage timely action in accordance with procedural deadline information.

The term “natural language processing method” refers to a computational approach for parsing, understanding, or extracting structured information from user-provided free-text data.

The term “speech synthesis technology” refers to electronic processing methods that generate audible spoken language from textual data for user support or guidance.

### Embodiments for Carrying Out the Invention

An embodiment of the present invention provides a system for supporting users in carrying out administrative or procedural applications, particularly those involving submission of required documents to public organizations. The system comprises a server equipped with a processor, a storage device, and communication hardware, as well as an information processing terminal such as a smartphone, tablet, or personal computer operated by the user. Both the server and the terminal utilize application programs and software modules that interact to realize the functions described in the claims.

The server employs a processor capable of running data validation, natural language processing, emotion analysis engines, and a generative artificial intelligence model for automated document creation. Example software employed may include general cloud-based natural language processing libraries (such as spaCy), emotion detection engines (such as openSMILE or commercially available cloud emotion analysis APIs), and generative models for document generation (such as a commercially available large language model API). The server stores procedural information resources, including the latest requirements and templates for applications, in a structured data storage such as a relational database.

The information processing terminal serves as the user interface and may be realized as a mobile phone or tablet equipped with a display, input device (keyboard or touchscreen), and a microphone for voice input. Application software running on the terminal may integrate speech recognition modules (such as a commercially available speech-to-text API) for transcribing user voice data. The terminal software can also provide real-time feedback and error checking for user input based on format and completeness.

In operation, the user initiates the application process by entering required data into the terminal. The terminal receives and transcribes user speech to text if the user utilizes voice input. The terminal verifies that all mandatory fields are provided and provides error messages for missing or incorrectly formatted data. Upon user confirmation, the terminal transmits the validated data securely to the server.

The server then processes the received data, performing tasks such as consistency verification, extraction of structured information using natural language processing, and cross-referencing with stored procedural requirements. For emotion analysis, if audio or behavioral cues are captured, the server processes these inputs via an emotion analysis tool and determines the user's emotional state. Depending on the emotional analysis, the server adjusts the interface tone by selecting appropriate instructions or messages for the user interface, which are relayed to the terminal.

The server constructs a prompt sentence for input to the generative artificial intelligence model, combining the user input and guidelines for document generation. An example prompt sentence is:
“I want to create an address change application for the city office. The user's new address is 1234 New Street, Hometown City. Please generate the necessary application document, and consider user support that reduces anxiety during stressful procedures. ”

Upon generating the document by the generative AI model, the server supplements the draft as needed with procedural details and returns the electronic document to the terminal. The terminal displays the completed document for the user's review, allowing the user to confirm, edit, or approve the content. The terminal may provide further guidance or voice instructions, utilizing a text-to-speech module to enhance accessibility.

If procedural deadlines are associated with the application, the server manages deadline information and instructs the terminal to notify the user via pop-up notifications or calendar alerts, helping ensure that actions are taken within required time frames.

For example, if a user needs to submit an application to change address at a public office, the system guides the user through the data entry, ensures all information is complete, determines if the user appears stressed, adapts the interaction to be reassuring, automatically generates the correct electronic document via the generative AI model, and sets reminders for important submission deadlines.

This structure, using widely available hardware and standard software tools with specified integration and workflow, allows the invention to be readily implemented and used in practical administrative scenarios.

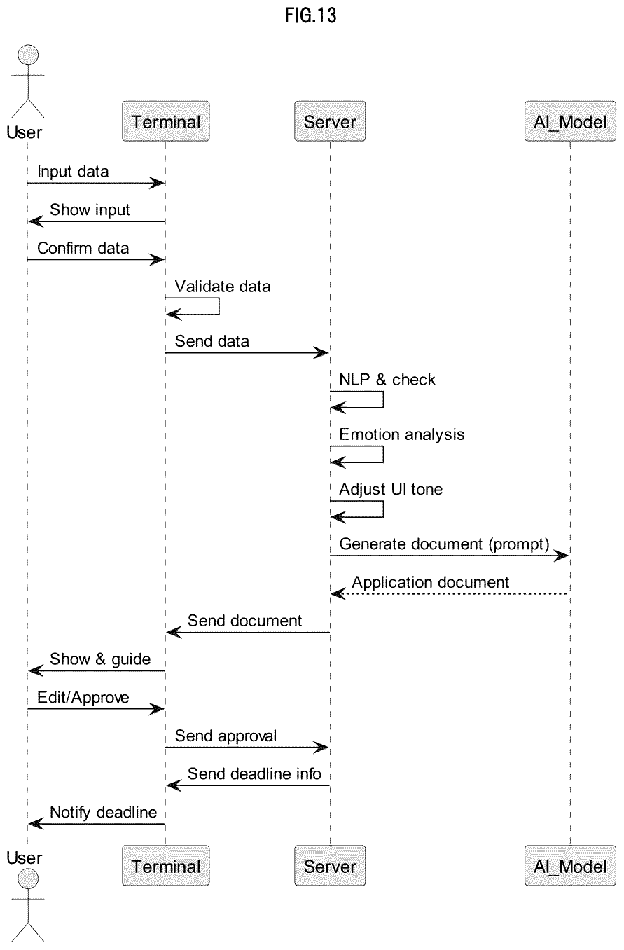

The following describes the processing flow using FIG. 13.

### Step 1:

The user operates the terminal to start an application procedure and inputs required information, such as personal details, address, and procedural purpose, using a keyboard or by speaking into the microphone. The input may be text or audio. The terminal receives the input, and if audio input is detected, it uses a speech-to-text engine to transcribe the user's speech into text. The output is a set of user input data in text format.

### Step 2:

The terminal analyzes the received text data to check for completeness and correctness. The input is the user input data in text format. The terminal performs data validation processes, such as verifying that all required fields are filled and formats are correct (e.g., date formatting, address structure). If errors are found, the terminal displays a specific error message instructing the user to correct the data. The output is a validated and error-checked set of user data.

### Step 3:

The terminal transmits the validated user data to the server over a secure network connection, such as HTTPS. The input is the finalized user data. No significant data processing is done at this step other than formatting the data for transmission. The output is the arrival of the user data at the server.

### Step 4:

The server receives the user data and performs further consistency and integrity checks. The input is the user data transmitted from the terminal. The server parses and analyzes the data using a natural language processing library to extract necessary information and to ensure logical consistency. The output is a cleaned and structured dataset ready for further processing.

### Step 5:

The server checks whether audio or behavioral data are available for emotion analysis. If so, the server inputs the speech audio or input speed/pattern into an emotion analysis engine. The engine processes the input to estimate the user's emotional state, such as stress or calmness. The output is an emotion assessment value or label, which is used to inform subsequent steps.

### Step 6:

The server determines if adaptation of the user interface is needed based on the emotion assessment. The input is the emotion analysis result. The server selects or generates an appropriate response tone or information presentation style, such as changing GUI colors or providing additional supportive messages. The output is a tone or style parameter for the next user interface update.

### Step 7:

The server constructs a prompt sentence integrating the user's input data and any support requirements indicated by the emotion analysis. The input is the structured user data and the support needs. The server formulates a prompt sentence for the generative AI model. For example: “Please generate an address change application for a new address at 1234 New Street, taking into account that the user feels anxious and needs step-by-step support. ” The output is a prompt sentence.

### Step 8:

The server inputs the prompt sentence into the generative AI model and obtains a draft application document. The input is the constructed prompt. The generative AI model processes the prompt and outputs a digital application document populated with the appropriate data fields. The output is the generated application document.

### Step 9:

The server supplements the generated application document with additional procedural details from the latest information aggregation (e.g., form submission instructions or required attachments). The input is the generated application document and procedural database information. The server merges or attaches this information, producing a finalized set of submission materials. The output is a complete package of application materials and guidance.

### Step 10:

The server transmits the finalized application materials to the terminal for user review. The input is the completed application package. The terminal receives and displays the materials, providing options for the user to view, edit, or approve them. The terminal may use a text-to-speech engine to deliver verbal instructions. The output is the application materials ready for user interaction.

### Step 11:

The user reviews the displayed application materials on the terminal, editing or approving them as needed. The input is the application materials presented by the terminal. The user interacts with the terminal to make edits or confirm approval. The output is a user-confirmed or edited set of application materials.

### Step 12:

The server manages procedural deadlines associated with the application. The input is the procedural deadline information linked to the application type. The server sends deadline data to the terminal, and the terminal schedules reminders or notifications using its built-in notification system. The output is scheduled alerts that prompt the user to complete required actions within the designated timeframe.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional electronic payment and application systems, user experiences are often hindered by a lack of consideration for users' emotional states, leading to confusion, anxiety, or stress during critical procedures such as payments or official document submission. Existing systems typically process user data and proceed with procedures mechanically, without providing dynamic guidance or emotional support. As a result, users may abandon transactions or make errors due to insufficient reassurance, inappropriate instructions, or unclear deadlines. Therefore, there is a need for a technically advanced system that analyzes users' behavioral or emotional states in real time and flexibly adapts the procedure flow, document generation, and user support messages to improve comfort, reliability, and procedural efficiency.

The specific processing by the specific processing unit 290 of the data processing device 12 in Application Example 2 is realized by the following means.

The present invention provides a server comprising a processor configured to receive user information and validate data formats, collect and update procedural information in a storage medium, generate application documents by combining validated user data with templates, provide generated documents and related information to user terminals, notify users of deadlines to prompt timely action, analyze user emotional states using behavioral or audio data with a learning model, and dynamically adjust payment procedures or user interface content based on such analysis via a processor or user terminal, as well as generate context-appropriate support messages using a generative artificial intelligence model. This enables personalized, emotionally adaptive guidance and support throughout electronic procedures, thereby enhancing user confidence, reducing procedural errors, and ensuring smoother and more reliable completion of various electronic transactions.

The term “processor” refers to a hardware component or a combination of hardware and software configured to execute programmed instructions for performing data processing tasks within the system.

The term “user” refers to an individual who interacts with the system to submit information, receive documents, perform electronic payments, or receive notifications or guidance.

The term “input data” refers to information provided by the user, including but not limited to personal information, transaction details, behavioral data, or audio data submitted through an input interface.

The term “format validation” refers to the process of verifying that input data conforms to predefined structural, syntactic, or lexical rules required by the system.

The term “procedural information” refers to data related to various procedures, such as applications, payments, or submissions, which may include requirements, deadlines, status, and related instructions.

The term “data storage medium” refers to any electronic, optical, or magnetic medium capable of storing, updating, or retrieving digital data related to system operations and user procedures.

The term “document template” refers to a predefined digital structure containing standardized fields and formatting, used as a basis for generating customized application documents with user-specific information.

The term “application data” refers to user-specific information combined and arranged within a document template to generate documents required for an electronic procedure or transaction.

The term “user terminal” refers to an electronic device, such as a smartphone, tablet, or computer, operated by the user to interact with the system, receive information, and display or transmit documents and notifications.

The term “deadline notification” refers to an alert or message delivered to the user indicating the required timing for an action related to a procedure, typically sent to encourage timely completion.

The term “behavioral data” refers to information that characterizes user actions during interaction with the system, including input speed, navigation patterns, and response times.

The term “audio data” refers to digitized representations of sounds, particularly the user's spoken voice input, acquired by the user terminal and transmitted to the processor for analysis.

The term “learning model” refers to a set of algorithms or computational methods trained on sample data to identify and infer emotional states or patterns from new behavioral or audio input data.

The term “emotional state” refers to the psychological condition of the user, such as being calm, anxious, stressed, or confused, as estimated by analysis of behavioral or audio data through a learning model.

The term “payment procedure” refers to the series of processes and user interface interactions involved in the completion of an electronic payment transaction.

The term “interface display content” refers to the arrangement and presentation of information, buttons, instructions, or support messages shown to the user through the user terminal.

The term “generative artificial intelligence model” refers to a computational model, often employing machine learning techniques, capable of generating text, messages, or content dynamically based on contextual input, such as emotional state or user behavior.

The term “support message” refers to textual, visual, or audio guidance or assistance presented to the user, tailored to the context and emotional state of the user, in order to facilitate smooth interaction with the system.

The system comprises a server including a processor, one or more user terminals, and a data storage medium. The server and the user terminals are connected via a communication network such as the Internet or a local area network.

The server is implemented on general-purpose computing hardware, such as a cloud computing instance, a physical server, or an edge computing device. The user terminal is realized by an electronic apparatus, such as a smartphone, tablet, or personal computer, capable of input and output operations. The data storage medium consists of a database system, such as a relational database management system or an equivalent structure.

The server executes a software application, which may be implemented using programming languages such as Python or Java. Data processing on the server leverages regular expression libraries for input validation (for example, using the re module in Python), as well as database access libraries to collect and update procedural information. For document generation, the server employs template engines such as Jinja2 and file format conversion tools to create PDF, DOCX, or other standard document records.

For emotion analysis, the server uses machine learning models, which may be implemented with frameworks such as TensorFlow or PyTorch. Speech-to-text functionality can be realized with commercially available APIs, for instance, a speech recognition cloud service. Natural language understanding, including sentiment determination, can be performed by language models based on the transformers architecture. A generative AI model, such as a large language model, is incorporated to generate support messages according to user emotional or behavioral context.

The user terminal runs an application or web browser interface, with the front-end developed in technologies such as React Native or Flutter. The terminal is capable of receiving, storing, and displaying document files, rendering interface content dynamically according to server instructions, and presenting both visual and audio information. Audio guide functionality is implemented using text-to-speech engines available on the terminal platform.

In a typical use scenario, the user operates a user terminal to access a payment or application procedure. The user enters required information, such as name, address, and payment details, through a graphical interface. In some cases, the user may provide audio input, which the terminal records and transmits to the server. The server validates the format of the input data and returns immediate feedback to the terminal, minimizing user errors.

Simultaneously, the server performs emotion analysis on the user's voice or behavioral data to detect anxiety, hesitation, or other emotional states. According to the outcome, the server dynamically customizes the interface display and support messages. For example, if the analysis indicates stress, the server instructs the terminal to present a calming visual theme and play a reassuring audio message.

The server automatically generates a required document for the procedure by merging validated user data with a stored document template. This generated document is transmitted to the user terminal, allowing the user to inspect and confirm the content. Terminals also notify users of approaching deadlines or pending actions by displaying pop-up messages or sending notification alerts.

A generative AI model is used by the server to create context-aware support messages. An example of a prompt sentence employed for the generative AI model is:
“The user appears to be anxious about making a high-value purchase. Please generate a friendly and reassuring support message to display on the payment confirmation page.”

Through the above configuration and processing, the system enables an adaptive, user-friendly, and emotionally intelligent electronic procedure environment, in which user confidence and accuracy are improved, and procedural completion rates are enhanced.

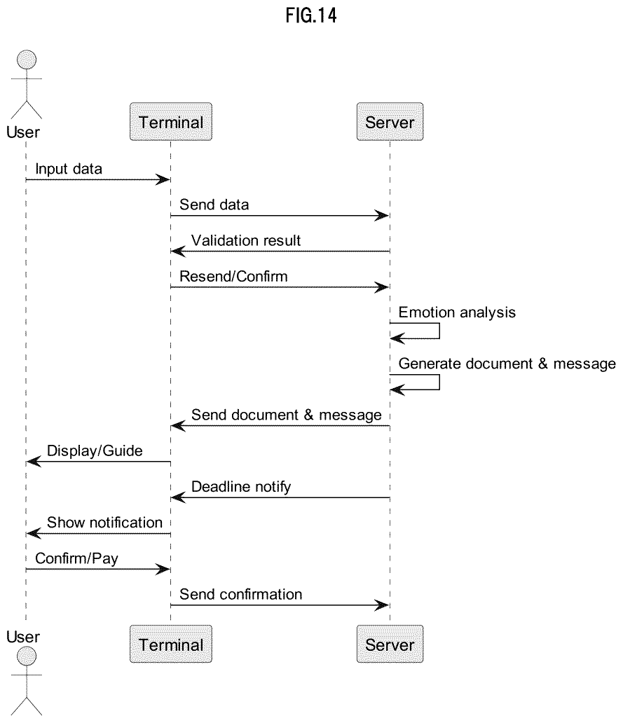

The following describes the processing flow using FIG. 14.

### Step 1:

The user operates the terminal to access the system's application or payment interface. The user inputs required data, such as name, address, and payment information, using graphical input fields, and may additionally record voice input if prompted. The terminal collects this information, transforms the text input into a structured data format such as JSON, and encodes audio data in a standard format such as WAV. As input, the terminal handles user-provided personal and transactional data. As output, the terminal transmits the combined input data (text and audio) to the server via a secure communication channel.

### Step 2:

The server receives the user's data and initiates input validation. The server uses regular expressions and validation rules to check that each field (e.g., address, credit card number) conforms to prescribed formats. As input, the server takes the structured data from the terminal. The server performs data processing by parsing each data field, applying format checks, and detecting any irregularities. The output is either a validation success response or an error message, which the server sends back to the terminal.

### Step 3:

The server analyzes the emotional state of the user using the received text and audio data. The server first converts audio into text using a speech-to-text process. Then, using a machine learning model (such as a pretrained sentiment analysis model), the server evaluates both the content and characteristics of the input (for example, the words used and the speed or tone of the speech). Input for this step includes transcribed text, raw audio features, and behavioral data (e.g., input timing). The output is one or more emotion labels (such as anxious, confident, or neutral), which are associated with the user session for further processing.

### Step 4:

The server collects the validated user data and combines it with the appropriate document template using a template engine. The server executes data mapping and insertion processes to fill the necessary fields in an application or payment document. Input for this step consists of validated structured user data and selected template information. The server's output is a new, customized document file (such as a PDF or DOCX), ready for delivery to the user.

### Step 5:

The server generates personalized support messages for the user. The server inputs the user's emotion label and procedural context into a generative AI model, along with a prompt sentence describing the support situation. The generative AI model processes the input and outputs a context-sensitive, emotionally adaptive message. The result is a text-based support message, and if required, an audio file generated by text-to-speech software. This output is packaged together with the generated document and sent to the terminal.

### Step 6:

The terminal receives the generated document and support message from the server. The terminal presents the document using an embedded document viewer, and displays the support message on the interface. If an audio version is included, the terminal plays the message aloud using its audio subsystem. Based on the emotion label, the terminal may also adjust visual elements, such as applying calming color themes. The input in this step is the server's response payload, and the output is a user-adjusted interface with guidance.

### Step 7:

The server monitors deadlines for the procedure, referencing stored timeline data. When a relevant deadline approaches, the server automatically creates a notification message and pushes it to the terminal. The terminal receives the notification and displays it in real-time to the user, such as a pop-up or banner alert. Input in this step is the registered procedural deadline; processing includes time comparison and message generation. Output is the real-time delivery of reminders to the terminal and, thus, to the user.

### Step 8:

The user reviews the generated document, listens to or reads the support message, and performs the final confirmation or payment action through the terminal interface. The terminal captures the user's completion action, such as pressing a confirm button or providing biometric authentication, and transmits this confirmation to the server. Input in this step is the user's final approval operation; output is a confirmation transaction sent to the server, which upon processing, completes the electronic transaction.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

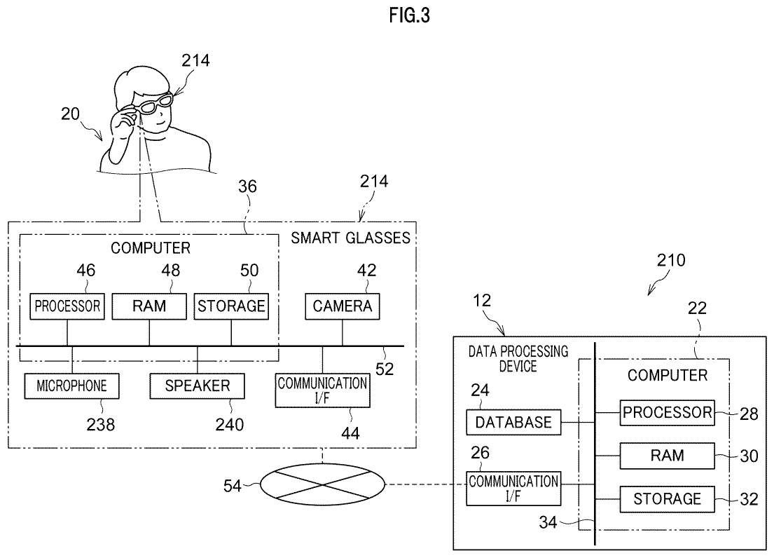

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

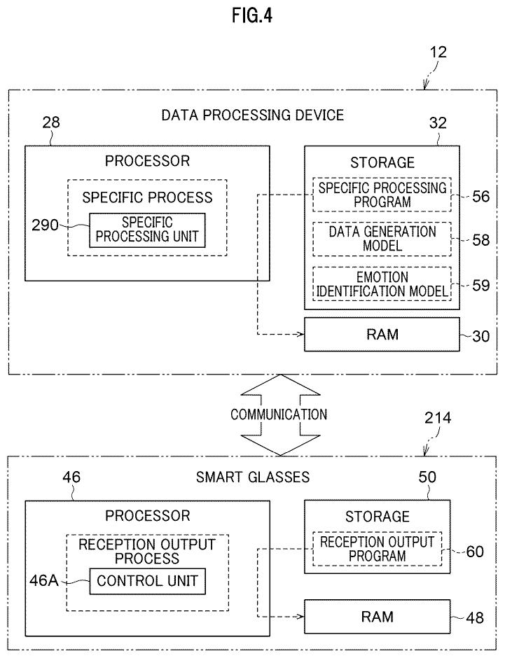

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

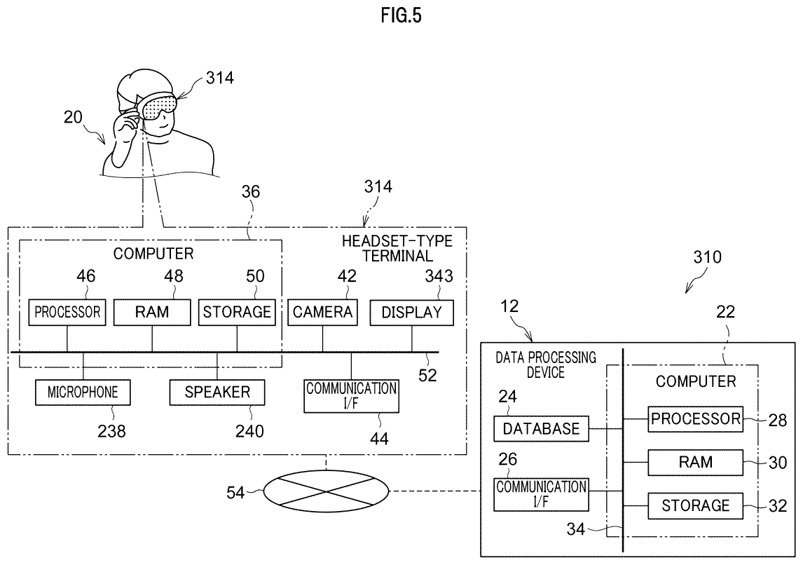

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

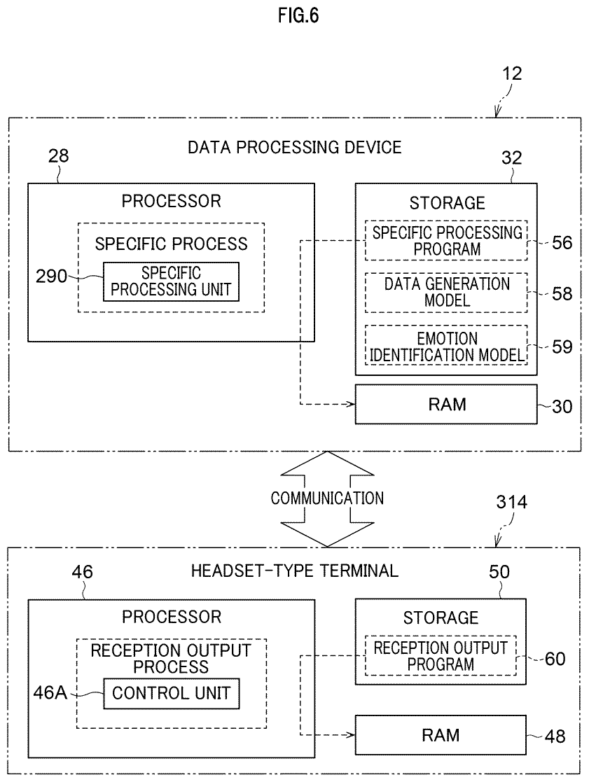

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

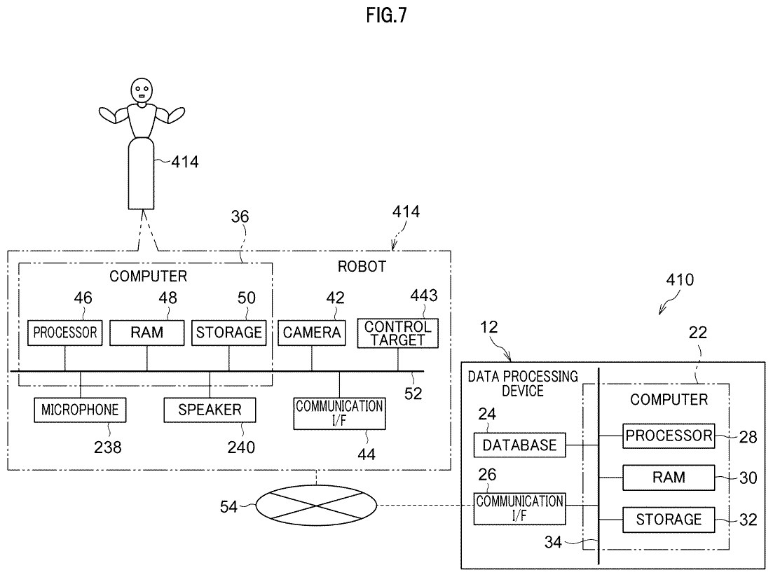

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

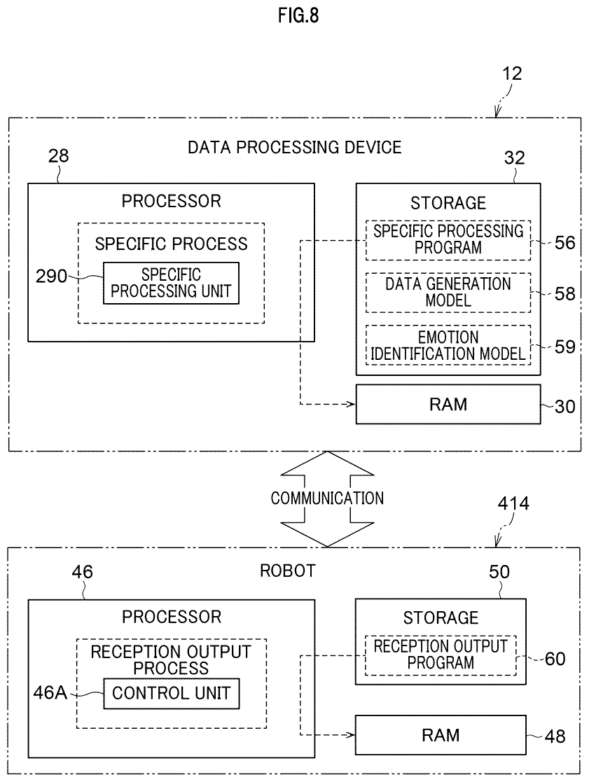

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

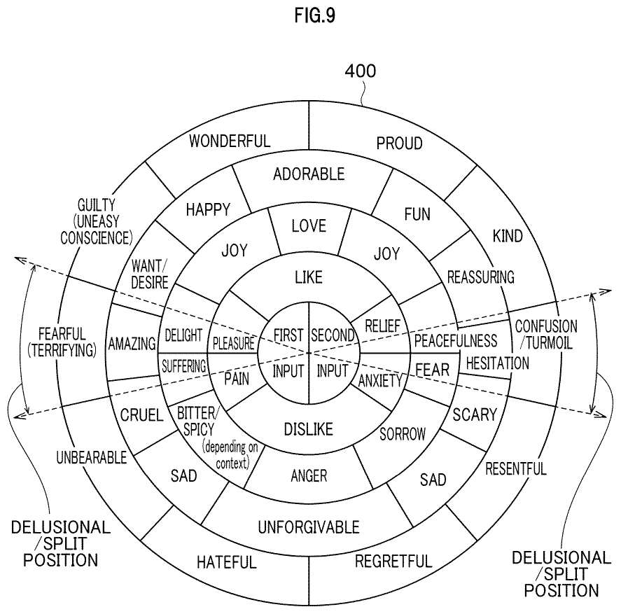

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

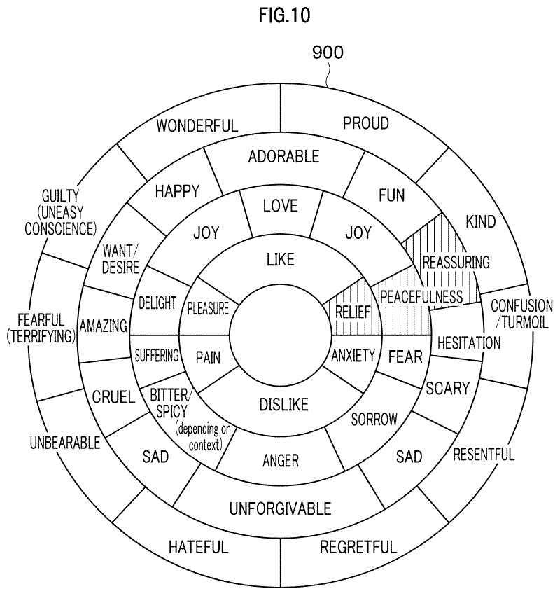

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive information from a user and verify the structure and logical consistency of input data, automatically collect information regarding administrative procedures from a plurality of public institutions via a communication network using information acquisition technology, store the collected information in a unified record structure in an information storage device, and periodically update the content,
generate a predetermined prompt sentence based on the verified user input data, input the prompt into a generative artificial intelligence model, extract application data from the generated text of the artificial intelligence model, and automatically assign each item of the application information record to thereby automatically generate an application document, output the generated application document and related procedural information visually or audibly on a display device, and provide the user with guidance information including necessary actions or submission destinations,
generate notification information based on deadline management information related to the application, send the notification information to the user's terminal before the deadline, and prompt the user to complete the procedure within the deadline.

### (Supplementary 2)

The system according to supplementary 1,
wherein the processor is configured to
analyze and structure the user input data using natural language processing technology, and utilize the analysis result for the application document generation process.

### (Supplementary 3)

The system according to supplementary 1,
wherein the processor is configured to
provide procedure guidance or deadline reminders to the user as audio signals using voice input/output technology.

### Application Example 1

### (Supplementary 1)

A system comprising a processor,
wherein the processor is configured to
acquire information from an input device and verify the format and completeness of the input information,
obtain information related to a plurality of procedures from external information sources via communication and store and update the information in an information storage device, construct and transmit a prompt sentence to a natural language generation processing device based on the received input information and the information in the information storage device, thereby automatically generating a medium used for application and automatically filling appropriate items in the medium,
present the generated medium and related information to a user via an output device and provide the user with an opportunity to revise or confirm,
enable electronic payment by controlling a payment processing device based on the content of the medium,
manage deadline information associated with the medium and provide a reminder notification to the user at a predetermined time using a notification device, and
estimate an emotional state based on input information or voice data from the user, and dynamically adjust the response content or guidance expression according to the analysis result.

### (Supplementary 2)

The system according to supplementary 1,
wherein the processor is configured to
extract intent and recognize items from the information acquired from the input device using natural language analysis processing.

### (Supplementary 3)

The system according to supplementary 1,
wherein the processor is configured to
present procedural guidance or supplementary information to the user as an audio signal using an output device and audio output processing, and variably control the voice expression according to the emotion estimation result.

### Example 2

### (Supplementary 1)

A system comprising a processor,
wherein the processor is configured to
receive input information from a user and verify completeness and consistency of the input information;
collect procedural information resources via a communication network and update an information aggregation in a storage device;
analyze a user's emotional state based on speech data or input operation patterns; dynamically adjust presentation content or response expressions of an operation interface according to the analyzed emotional state;
construct an instruction sentence for a generative artificial intelligence model and generate an application electronic document automatically based on the input information by supplementing with appropriate information;
transmit the generated electronic document and related information to an information processing terminal and provide these in a manner that allows the user to view and modify them;
manage procedural deadline information and notify the user to prompt action within a predetermined period.

### (Supplementary 2)

The system according to supplementary 1,
wherein the processor is configured to
analyze structure of the input information using a natural language processing method and perform extraction of information required for the procedure and evaluation of data quality.

### (Supplementary 3)

The system according to supplementary 1,
wherein the processor is configured to
provide dialog-based voice support or operation guidance to the user using a speech synthesis technology.

### Application Example 2

### (Supplementary 1)

A system comprising a processor,
wherein the processor is configured to
receive information from a user and validate a format of input data,
collect information regarding a plurality of procedures and update a data storage medium, automatically generate application data by combining the received input data with a document template and inserting necessary items,
provide the generated application data and related information to a user terminal by displaying or transmitting,
notify the user and promote an action based on deadline information related to the procedures, analyze an emotional state of the user by processing behavioral data or audio data obtained from the user using a learning model,
dynamically adjust a payment procedure or interface display content based on the analyzed emotional state using the processor or a user terminal, and
generate a support message in accordance with the emotional state or context for a payment screen or procedure guide screen using a generative artificial intelligence model.

### (Supplementary 2)

The system according to supplementary 1,
wherein the processor is configured to analyze information or behavioral data of the user using natural language processing technology or machine learning technology.

### (Supplementary 3)

The system according to supplementary 1,
wherein the processor is configured to provide support information to the user via an audio output device or a display device according to the analysis of the emotional state or operation status of the user.

What is claimed is:

1. A system comprising a processor,
the processor being configured to:
receive information from a user and check format of input data;
collect information regarding various procedures and update a database;
automatically generate a document for application purposes based on the received input data and fill in appropriate fields,
provide the generated document and related information to the user; and
notify the user of a set deadline and prompt action.

2. The system according to claim 1, wherein the processor is further configured to analyze the user's input data using natural language processing technology.

3. The system according to claim 1, wherein the processor is further configured to provide a voice guide to the user.
